(19) United States
(12) Patent Application Publication
(10) Pub. No.: US 2025/0079787 A1
(43) Pub. Date: Mar. 6, 2025

(54) PERFORMANCE ENHANCEMENT OF YTTERBIUM-DOPED FIBER AMPLIFIER EMPLOYING A DUAL-STAGE IN-BAND ASYMMETRICAL PUMPING

(71) Applicant: KING FAHD UNIVERSITY OF PETROLEUM AND MINERALS, Dhahran (SA)

(72) Inventors: Khurram Karim QURESHI, Dhahran (SA); Muhammad Jawad MIRZA, Islamabad (PK); Salman Abdul GHAFOOR, Islamabad (PK); Ammar ARMGHAN, Sakaka (SA)

(73) Assignee: KING FAHD UNIVERSITY OF PETROLEUM AND MINERALS, Dhahran (SA)

(21) Appl. No.: 18/510,102

(22) Filed: Nov. 15, 2023

Related U.S. Application Data
(60) Provisional application No. 63/580,573, filed on Sep. 5, 2023.

(51) Int. Cl. H01S 3/067; H01S 3/094; H01S 3/16

(52) U.S. Cl. CPC H01S 3/06716; H01S 3/06729; H01S 3/094003; H01S 3/094096; H01S 3/1618

(57) ABSTRACT

A system for amplifying optical signals includes a first isolator configured to generate a first isolated signal, a first pump, a first coupler for generating a first pumped signal, a first ytterbium doped fiber for receiving the first pumped signal and converting the first pumped signal to a first amplified signal, a second isolator for converting the first amplified signal into a second isolated signal, a second pump, a second coupler for generating a second pumped signal, a second ytterbium doped fiber configured to receive the second pumped signal and convert the second pumped signal into a second amplified signal, and a third isolator configured to receive the second amplified signal and convert the second amplified signal into an amplified optical signal. The first pump and the second pump are configured as co-propagating in-band asymmetrical pump sources for the first and second photons.

### STATEMENT REGARDING PRIOR DISCLOSURE BY THE INVENTORS

This application claims priority to U.S. Application Ser. No. 63/580,573, filed Sep. 5, 2023, the entire contents of which are hereby incorporated by reference. Aspects of this technology are described in an article “Performance enhancement of ytterbium-doped fiber amplifier employing a dual-stage in-band asymmetrical pumping”, published in Optical Sensing and Devices Micromachines 2022, 13, 1488, which is also incorporated herein by reference in its entirety.

### BACKGROUND

### Technical Field

The present disclosure is directed to the performance enhancement of an ytterbium-doped fiber amplifier by employing dual-stage in-band asymmetrical pumping.

### Description of Related Art

The “background” description provided herein is for the purpose of generally presenting the context of the disclosure. Work of the presently named inventors, to the extent it is described in this background section, as well as aspects of the description which, may not otherwise qualify as prior art at the time of filing, are neither expressly or impliedly admitted as prior art against the present invention.

The number of internet users as well as the use of various high bandwidth applications such as voice over IP, video conferencing, online gaming, high definition video streaming, and social networking is increasing. Due to intensified Internet usage and demand for network capacity, optical fiber networks and wavelength-division multiplexing (WDM) networks have increased over the past few years. An optical amplifier is a device that amplifies an optical signal directly, without the need to first convert it to an electrical signal. Optical amplifiers play an important role in optical fiber networks and WDM networks, enabling the transmission of many terabits of data over distances from a few hundred kilometers to thousands of kilometers by overcoming fiber loss limitations. Some examples of optical amplifiers include, but are not limited to, semiconductor optical amplifiers (SOA), Fiber Raman and Brillouin optical amplifiers and rare earth-doped fiber optical amplifiers. In the rare earth-doped fiber optical amplifier, stimulated emission in the amplifier's gain medium causes amplification of incoming light (optical signal). The rare earth-doped fiber optical amplifier amplifies the signal in the optical domain as well as provides a high gain to multiple optical wavelengths simultaneously. In the fabrication of rare earth-doped fiber optical amplifiers, rare-earth dopants such as erbium, thulium, praseodymium, and ytterbium are used.

The major limitation of erbium, praseodymium, thulium, and holmium is zero-emission around the 1 μm wavelength region, disqualifying them for various applications around the 1 μm wavelength region. However, ytterbium has excellent emission characteristics around the 1 μm wavelength region, realizing it as a suitable option for realizing the high gain and high output power in rare earth doped-fiber amplifiers. An ytterbium-doped fiber amplifier (YDFA) has various attractive features that include broad gain bandwidth, high output power, high pump conversion efficiency (PCE), low thermal load, and reliable fiber geometry. A wide range of pump wavelengths (0.86 μm-1.064 μm) are available to excite the gain medium in YDFA. It is required to achieve high output power ytterbium-doping-based fiber laser and amplifier systems. For instance, existing single transverse mode YDFAs are capable of generating output power >2 kW and >320 W when the input signal is in continuous wave (CW) or pulsed format, respectively. Similarly, it is also possible to attain high small-signal gain by incorporating a short length of fiber doped with ytterbium.

A YDFA based on a double-pass two-stage configuration to study the evolution of gain and output power for different lengths of ytterbium-doped fiber (YDF) and different pump powers was described (See: Liu, Y.; Zhang, Y.; Xiao, Y.; Lu, Y, “The gain characters and optimization of the double-pass two-stage ytterbium-doped fiber amplifier,” in proceedings of the 2009 IEEE symposium on photonics and optoelectronics, Wuhan, China, 14-16 Aug. 2009; pp. 1-4). However, the described YDFA has a maximum gain of 25 dB. Further, an efficient and improved ytterbium-doped fiber amplifier (YDFA) having two pumping schemes has been described (See: Liu, Y.; Wang, C.; Lu, Y, “Gain characteristics of an ytterbium-doped fiber amplifier at 1064 nm”, advanced laser technologies; international society for optics and photonics (SPIE): Bellingham, WA, USA, 2006; Volume 6344, p. 63440L). This reference is able to attain a peak gain of around 45 dB.

Also, Yb-doped fiber lasers operating near 0.98 μm have been described (See: Aleshkina, S. S.; Lipatov, D. S.; Kotov, L. V.; Temyanko, V. L.; Likhachev, M. E, “All-fiber single-mode PM Yb-doped pre-amplifier at 0.976 μm”, in proceedings of the 2019 IEEE Conference on Lasers and Electro-Optics Europe & European Quantum Electronics Conference (CLEO/Europe-EQEC), Munich, Germany, 23-27 Jun. 2019). This amplifier operates at 915 nm and does not allow output power higher than ˜100 mW. A master oscillator-power amplifier (MOPA) for the YDFA to measure small-signal gain and saturated output power has been described (See: Mohammadian, S.; Parvin, P.; Ilchi-Ghazaani, M.; Poozesh, R.; Hejaz, K., “Measurement of gain and saturation parameters of a single-mode Yb: Silica fiber amplifier,” Opt. Fiber Technol. 2013, 19, 446-455). The MOPA is employed for single mode and double clad fiber, and the maximum gain and saturated output power of 25 dB and 300 mW, respectively, were obtained.

A YDFA which generates output power of 6.8 W at 0.98 μm by employing a 60/130 double clad YDF and cladding-mode amplification scheme has been described (See: Yu, Y.; An, Y.; Cao, J.; Guo, S.; Xu, X., “Experimental study on all-fiberized continuous-wave Yb-doped fiber amplifier operating near 980 nm”, IEEE Photonics Technol. Lett. 2016, 28, 398-401). Single and double-pass YDFA configurations have been described, where a double-pass configuration employing a 5 m length of YDF performs better than the single-pass by giving a maximum gain of 24.6 dB (See: Mohammed, D. Z.; Al-Janabi, A. H., “Performance analysis on single- and double-pass ytterbium-doped fiber amplifier in the 1 μm Region”, Fiber Integr. Opt. 2020, 39, 264-272). However, the amplifiers described in these references and other conventional systems suffer from various limitations including various distortion effects typically associated with the saturation mechanism and gain dynamics of the amplifier.

Hence, there is a need for a system for amplifying optical signals that has improved gain, high output power, and a minimum noise figure (NF).

### SUMMARY

In an embodiment, a system for amplifying optical signals is described. The system includes a first isolator configured to receive an input signal and convert the input signal into a first isolated signal, a first pump configured to generate first pump photons, a first coupler configured to receive and join the first isolated signal and the first pump photons into a first pumped signal, a first ytterbium doped fiber configured to receive the first pumped signal and convert the first pumped signal to a first amplified signal, a second isolator configured to receive the first amplified signal and convert the first amplified signal into a second isolated signal, a second pump configured to generate second pump photons, a second coupler configured to receive and join the second isolated signal and the second pump photons into a second pumped signal, a second ytterbium doped fiber configured to receive the second pumped signal and convert the second pumped signal into a second amplified signal, and a third isolator configured to receive the second amplified signal and convert the second amplified signal into an amplified optical signal. The first pump and second pump are configured as co-propagating in-band asymmetrical pump sources for the first and second photons.

In another exemplary embodiment, a system for amplifying optical signals is described. The system includes a first isolator configured to receive an input signal and convert the input signal into a first isolated signal, a first pump configured to generate first pump photons, a first coupler configured to receive and join the first isolated signal and the first pump photons into a first pumped signal, a first gain medium configured to receive the first pumped signal and convert the first pumped signal to a first amplified signal, a second isolator configured to receive the first amplified signal and convert the first amplified signal into a second isolated signal, a second pump configured to generate second pump photons, a second coupler configured to receive and join the second isolated signal and the second pump photons into a second pumped signal, a second gain medium configured to receive the second pumped signal and convert the second pumped signal into a second amplified signal, and a third isolator configured to receive the second amplified signal and convert the second amplified signal into an amplified optical signal. The first gain medium is excited using a wavelength with a lower photon absorption rate than the second gain medium. The first pump is operated at a minimum power with respect to the power at which the second pump is operated.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A represents an absorption cross section and an emission cross section of Yb³⁺;

FIG. 1B represents an energy level diagram of Yb³⁺;

FIG. 2 is a schematic diagram of a system for amplifying optical signals, according to aspects of the present disclosure;

FIG. 3A represents a forward pumping configuration to excite a gain medium of a conventional ytterbium-doped fiber amplifier (YDFA);

FIG. 3B represents a backward pumping configuration of the conventional YDFA;

FIG. 3C represents a bidirectional pumping configuration of the conventional YDFA;

FIG. 4A is a graph illustrating gain of the conventional YDFA when length of an ytterbium-doped fiber (YDF)=2.5 m, and total pump power and doping concentration are fixed;

FIG. 4B is a graph illustrating the gain of the conventional YDFA when the length of the YDF=5 m and the total pump power and the doping concentration are fixed;

FIG. 4C is a graph illustrating the gain of the conventional YDFA when the length of the YDF=7.5 m, and the total pump power and the doping concentration are fixed;

FIG. 4D is a graph illustrating the gain of the conventional YDFA when signal wavelength=25×10²⁴ m⁻³, and the total pump power and the length of the YDF are fixed;

FIG. 4E is a graph illustrating the gain of the conventional YDFA when the signal wavelength=50×10²⁴ m⁻³, and the total pump power and the length of the YDF are fixed;

FIG. 4F is a graph illustrating the gain of the conventional YDFA when the signal wavelength=75×10²⁴ m⁻³, and the total pump power and the length of the YDF are fixed;

FIG. 5A is a graph illustrating signal wavelength versus gain of system at different lengths of a second ytterbium doped fiber, according to aspects of the present disclosure;

FIG. 5B is a graph illustrating signal wavelength versus gain of the system at different doping concentrations of Yb³⁺, according to aspects of the present disclosure;

FIG. 6A is a graph illustrating signal wavelength versus gain of the system at different pump powers, according to aspects of the present disclosure;

FIG. 6B is a graph illustrating signal wavelength versus gain of the system at different signal powers, according to aspects of the present disclosure;

FIG. 7A is a graph illustrating pump power versus output power of the system, according to aspects of the present disclosure;

FIG. 7B is a graph illustrating pump power versus gain of the system, according to aspects of the present disclosure;

FIG. 8A is a graph illustrating pump wavelength versus output power of the system, according to aspects of the present disclosure;

FIG. 8B is a graph illustrating pump wavelength versus gain of the system, according to aspects of the present disclosure;

FIG. 9A is a graph illustrating output power versus gain of the system as a function of pump power, according to aspects of the present disclosure;

FIG. 9B is a graph illustrating signal wavelength versus amplified spontaneous emission (ASE) of the system as a function of pump power, according to aspects of the present disclosure;

FIG. 10 is a graph illustrating signal power versus gain of the system as a function of pump power, according to aspects of the present disclosure;

FIG. 11A is a graph illustrating signal wavelength versus noise figure (NF) of the system as a function of signal power when the power of a first pump is 1 W, and the power of a second pump is 4 W, according to aspects of the present disclosure; and

FIG. 11B is a graph illustrating signal wavelength versus NF of the system as a function of signal power when the power of the first pump is 4 W, and the power of the second pump is 1 W, according to aspects of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to a system for amplifying optical signals. The present disclosure describes that performance of doped fiber amplifiers can be significantly enhanced using a multi-stage pumping technique. The present system defines various parameters for pumps, including their optical power and signal wavelength. By adjusting the optical power and wavelength of pumps in both pumping stages (a first pumping stage, and a second pumping stage), a peak gain of around 62.5 dB and an output power of 4.5 W are achieved for a signal wavelength of 1.0329 μm at a defined length of Ytterbium-doped silica fiber and an optimized doping concentration of Yb³⁺. Moreover, a minimum noise figure (NF) of 4 dB is observed for the signal wavelength of 1.0329 μm at the defined parameters. Similarly, the effect of using high pump power and low pump power on NF of the amplifier is also investigated at different values of signal powers. From experiments, it was evident that the value of NF increases significantly by using high pump power in the first pumping stage and low pump power in the second pumping stage.

In various aspects of the disclosure, non-limiting definitions of one or more terms that will be used in the document are provided below.

The term “gain medium” refers to a material that has quantum properties to amplify laser beams through a process of stimulated emission. The gain medium is a source of optical gain within a laser device which results from emission of molecular or electronic transitions from a higher energy state to a lower energy state.

The term “amplified spontaneous emission” (ASE) refers to light produced either by spontaneous emission or light that has been optically amplified by the process of stimulated emission in a gain medium.

The term “optimized parameter” is defined as a parameter at which an optical signal amplifier yields a highest gain. In an example, the optimized parameter may be an optimized length, an optimized pump power or an optimized dopant (Pr³⁺) concentration.

The term “gain medium excitation wavelength” refers to a specific wavelength of light that is used to excite or stimulate a gain medium in a laser or amplifier system. The gain medium excitation wavelength is selected to match the absorption characteristics of the gain medium material, allowing maximum energy transfer and population inversion to occur.

The term “amplified spontaneous emission (ASE) noise” refers to unwanted spontaneous emission of photons in an optical amplifier that can degrade the performance of a system. ASE noise can increase the noise level in the amplified signal, leading to a decrease in the signal-to-noise ratio.

The term “broadening in the gain medium” refers to the phenomenon where the spectral width of the amplification process increases.

The term “noise figure (NF)” of an optical amplifier is defined as the ratio of input signal-to-noise ratio to the output signal-to-noise ratio and usually is expressed in dB.

The term “3 dB saturated output power” refers to a power level at which an output signal reaches its maximum capacity. It is a measure of how much power the system can handle before distortion occurs. When the output power reaches this level, the system will start to clip or distort the signal, affecting the quality of the output.

The term “isolated signal” refers to a signal that has passed through

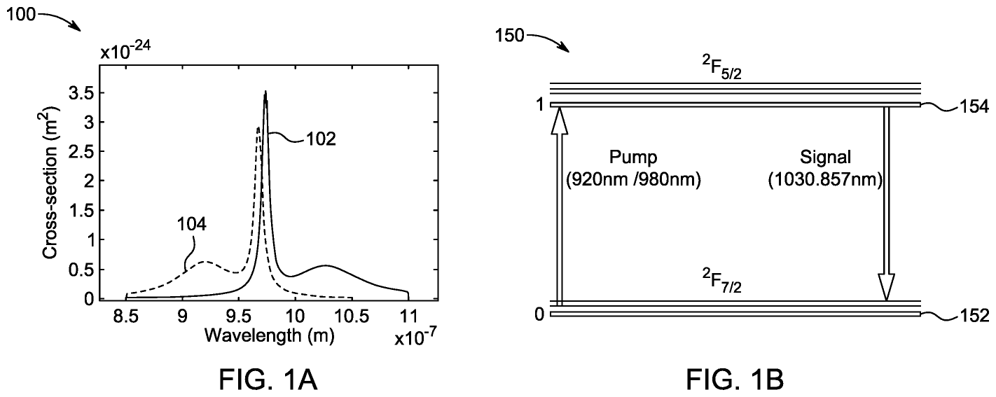

FIG. 1A-FIG. 1B represent spectroscopic properties of Yb³⁺ in silica host. The spectroscopic properties of a material refer to the study of how the material interacts with electromagnetic radiation. The spectroscopic properties involve the measurement and analysis of various characteristics such as absorption, emission, or light scattering by the material. Silica is the most commonly used host material for the fabrication of optical fibers. In some instances, other materials, such as fluoride glass, are also often used for doping with Yb³⁺. The gain dynamics of a ytterbium-doped fiber amplifier (YDFA) for a particular host material may be entirely different from other materials. In the present disclosure, due to the suitability of silica as the host material, silica is used as the host material. The spectroscopic properties of Yb³⁺ are straightforward as compared to other rare-earth dopants.

FIG. 1A is a graph 100 illustrating an emission cross section and an absorption cross section of Yb³⁺ in silica glass. The emission cross section represents the efficiency of the material in releasing energy as radiation. Curve 102 represents the emission cross section of Yb³⁺.

The absorption cross section refers to a measure of how effectively a material can absorb the energy of incident radiation at a specific wavelength. Curve 104 represents the absorption cross section of Yb³⁺. A larger absorption cross section indicates a higher probability of absorption, while a smaller cross section suggests a lower probability. Both cross sections (the absorption cross section and the emission cross section) are important for understanding the behavior of the material in electromagnetic radiation processes.

FIG. 1B represents an energy level diagram 150 of Yb³⁺. For laser sources for 1 μm, ytterbium dopant is preferred. Ytterbium has a simple energy level scheme with inherently two levels i.e., ²F_{5/2} excited state manifold (154), and ²F_{7/2} ground state manifold (152), as shown in FIG. 1B. These manifolds (152, 154) include various sub-energy levels, and the transitions between these sub-energy levels are not fully resolved at room temperature. Pumping and laser transitions occur between the various sub-energy levels of each manifold. For the pumping of Yb³⁺ doped systems, wavelengths ranging from 0.9 μm to 1 μm can be used, with the laser transitions centered above 1 μm. The higher sub-energy levels of the ground state (152) function as a lower laser level, thereby making the Yb-doped laser systems work as a quasi-three level system. The simple energy level scheme of Yb³⁺ ensures the absence of various detrimental effects such as excited state absorption and cross-relaxation.

From FIG. 1B, it may be observed that although a wide range of pump wavelengths (0.86-1.064 μm) are available to excite the Yb³⁺, maximum absorption of the pump photons takes place around 0.910 μm and 0.980 μm with emission of signal photons around 1 μm. Therefore, in the present disclosure, only one transition was employed in both of the pumping stages, from ²F_{7/2}→²F_{5/2} as shown in FIG. 1B.

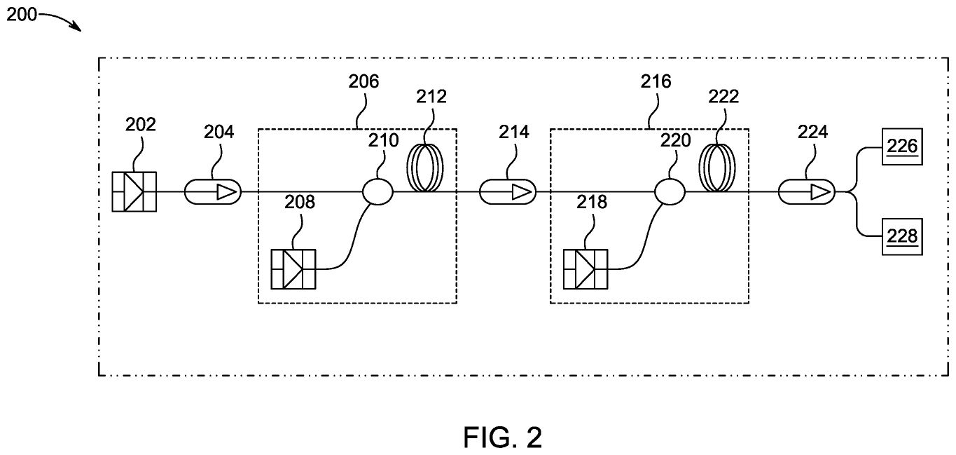

FIG. 2 is a schematic diagram of a system 200 for amplifying optical signals, according to aspects of the present disclosure. As shown in FIG. 2, the system 200 includes various components such as a first isolator 204, a first pump 208, a first coupler 210, a first ytterbium doped fiber (YDF) 212, a second isolator 214, a second pump 218, a second coupler 220, a second ytterbium doped fiber (YDF) 222, a third isolator 224, an optical power meter (OPM) 226 and an optical spectrum analyzer (OSA) 228. The system 200 includes two pumping stages, inter alia, a first pumping stage 206 and a second pumping stage 216.

As shown in FIG. 2, a signal laser 202 is configured to generate an input signal (signal laser beam). In an example, the input signal has a wavelength in between 1.02 μm and 1.08 μm. In an aspect, the signal laser 202 may be a feedback laser, a non-feedback laser, an Nd:YAG laser, a CO₂ laser, a Nd:YVO₄ laser, and a green laser. In some examples, the signal laser 202 (transmitting optics) includes inter alia, such as a neodymium-doped yttrium aluminum garnet (Nd:YAG) laser, an optical attenuator, a Galilean beam expander, a collimator, and a diffuser. In some examples, the signal laser 202 is a continuous-wave laser or a pulsed laser. The continuous-wave (CW) laser is configured to produce a continuous, uninterrupted beam of light, ideally with a very stable output power.

The first isolator 204 is connected to the signal laser 202. The first isolator 204 is configured to receive the generated input signal from the signal laser 202 and convert the received input signal into a first isolated signal. For example, the first isolator 204 is a passive magneto-optic device that allows generated signal laser beam to travel in one direction. It is desirable that the input signal (signal laser beam) of the signal laser 202 is optically isolated to prevent back reflections from damaging the signal laser 202 or causing undesirable optical interactions. The optical isolation is performed using an optical isolator through which the signal laser beam of the signal laser 202 is coupled. Therefore, the first isolator 204 is used to prevent back reflected light from returning to the signal laser 202. The first isolator 204 is configured to ensure the unidirectional operation of the signal laser 202. In an aspect, the first isolator 204 prevents unwanted feedback into an optical oscillator, such as a laser cavity. In some aspects, the first isolator 204 is configured to improve the isolation between the signal laser 202 (an optical source) and a transmission link in an optical communications system. The isolators (the first isolator 204, the second isolator 214, and the third isolator 224) are used for reducing the back reflections, which may affect the operation of the system 200, and stabilizing the operation of the system 200 by preventing it from reflected laser beam.

The first pumping stage 206 includes the first pump 208, the first coupler 210, and the first YDF 212. In the first pumping stage 206, the first YDF 212 acts as a gain medium.

The first pump 208 is configured to generate first pump photons. The first pump 208 is configured to transfer energy from an external source into the gain medium of the first pumping stage 206. The transferred energy is absorbed by the gain medium, producing excited states in its atoms. When the number of particles in one excited state exceeds the number of particles in the ground state or a less-excited state, population inversion is achieved. Population inversion is a process of achieving a greater population of a higher energy state as compared to the lower energy state. The population inversion causes emission transitions from a laser upper level to a laser lower level. These emission transitions are transitions emitting photons in an intended wavelength band. In an aspect, the first pump 208 is selected from the group consisting of a solid state laser, a Nd:YAG laser, a Nd:YLF laser, laser diodes, a semiconductor laser, and a cladding pump fiber.

In an aspect, the first pump 208 is configured to operate at a power in between 2 Watts and 6 Watts. In an operative aspect, the gain medium of the first pumping stage 206 is pumped through the first pump 208 operating at the signal wavelength of 0.92 μm and an optimized pump power of 1 W. In an example, the first pump 208 has a signal attenuation of 0.15 dB. Signal attenuation may refer to any signal loss which occurs as the result of signal transmission.

The first coupler 210 is connected to the first isolator 204 and the first pump 208. The first coupler 210 is configured to receive the first isolated signal from the first isolator 204 and the first pump photons from the first pump 208 simultaneously. The first coupler 210 is configured to join the received first isolated signal and the first pump photons and generate a first pumped signal. In an example, the first coupler 210 is a wave division multiplexer coupler. In another example, the first coupler 210 is a dual-port WDM analyzer.

The silica based glass optical fiber (the first YDF 212) is configured to receive the first pumped signal from the first coupler 210. The first YDF 212 is configured to convert the first pumped signal to a first amplified signal. The ytterbium Yb³⁺ ions of the first YDF 212 are configured to receive energy from the first pumped signal and release a number of supplementary photons. The released amount of the supplementary photons further amplifies the first pumped signal and generates the first amplified signal.

In a structural aspect, the first YDF 212 has a length of about 1 meter and a Yb³⁺ concentration of about 50×10²⁴ m⁻³. The first YDF 212 has a first gain medium excitation wavelength.

In a structural aspect, the silica based glass optical fiber includes three basic concentric elements: a core, a cladding, and an outer coating. The core is the light-transmitting portion of the fiber. The cladding usually is made of the same material as the core, but with a slightly lower index of refraction (usually about 1% lower). This index difference causes total internal reflection to occur at the index boundary along the length of the fiber so that the light is transmitted down the fiber and does not escape through the sidewalls. The outer coating usually includes one or more coats of a plastic material to protect the fiber from the physical environment. In an aspect, the first YDF 212 has a core radius of 3.4 μm. In another example, the first YDF 212 has a doping radius of 2.4 μm. The first YDF 212 has a cladding radius of 62.5 μm. In an example, the first YDF 212 may be a core-pumped YDF or a cladding-pumped (double clad) YDF. Core radius may refer to the radial distance of a cross section of the core of a YDF. Cladding radius may refer to the radial distance of a cross section of YDF which has a lower refractive index than the core of the YDF and is in intimate contact with the core of the YDF.

The second isolator 214 is configured to receive the first amplified signal from the first YDF 212 and convert the first amplified signal into a second isolated signal. The second isolator 214 allows the first amplified signal to propagate through it in one direction, but not in the opposite direction. The second isolator 214 is configured to feed the second isolated signal into the second pumping stage 216.

The second pumping stage 216 includes the second pump 218, the second coupler 220, and the second YDF 222. In the second pumping stage 216, the second YDF 222 acts as the gain medium.

The second pump 218 is configured to generate second pump photons. In an aspect, the second pump 218 is operated at a power between 2 Watts and 6 Watts. In an example, the second pump 218 is operated at a wavelength of 0.98 μm and a power of 4 Watts. In an example, the second pump 218 has a signal attenuation of 0.15 dB.

The second coupler 220 is connected to the second isolator 214 and the second pump 218. The second coupler 220 is configured to receive the second isolated signal from the second isolator 214 and the second pump photons from the second pump 218 simultaneously. The second coupler 220 is configured to join the received second isolated signal and the second pump photons and generate a second pumped signal.

The second YDF 222 is configured to receive the second pumped signal from the second coupler 220. The ytterbium Yb³⁺ ions of the second YDF 222 are configured to receive energy from the second pumped signal and release a number of supplementary photons. The released supplementary photons further amplifies the second pumped signal and generates a second amplified signal. In an aspect, the second YDF 222 has a length of 6 meters and a Yb³⁺ concentration of 50×10²⁴ m⁻³. In an aspect, the second YDF 222 has a core radius of 3.4 μm. In an example, the second YDF 222 has a doping radius of 2.4 μm. For example, the second YDF 222 has a cladding radius of 62.5 μm. The second YDF 222 has a second gain medium excitation wavelength. For example, the first gain medium excitation wavelength is lower than the second gain medium excitation wavelength. The first gain medium excitation wavelength is at a minimum with respect to the second gain medium excitation wavelength and the second gain medium excitation wavelength is at a maximum with respect to the first gain medium excitation wavelength. Doping radius may refer to the radial distance of a cross section of YDF in which a dopant has been introduced.

A first wavelength being at a minimum with respect to a second wavelength may indicate that this first wavelength is as low as possible with respect to the second wavelength, while preserving the functionality of the system. A first wavelength being at a maximum with respect to a second wavelength may indicate that this first wavelength is as high as possible with respect to the second wavelength, while preserving the functionality of the system.

In an aspect, the first gain medium (first YDF 212) is excited using a wavelength with a lower photon absorption rate than the second gain medium (second YDF 222). The first pump 208 is operated at a minimum power with respect to the power at which the second pump 218 is operated.

The third isolator 224 is configured to receive the second amplified signal from the second YDF 222. The third isolator 224 converts the second amplified signal into an amplified optical signal. The first pump 208 and the second pump 218 are configured as co-propagating in-band asymmetrical pump sources for the first pump photons and the second pump photons.

The third isolator 224 is configured to ensure unidirectional operation of the amplified optical signal. The third isolator 224 is configured to transmit the amplified optical signal to the OSA 228 and the OPM 226. The amplified optical signal is configured to prevent the amplified laser beam from reflecting back into the second YDF 222.

The OPM 226 is commutatively connected to the third isolator 224 and receives the amplified optical signal from the third isolator 224. The OPM 226 is configured to measure an amplitude of the received amplified optical signal. In an aspect, the OPM 226 is used to measure an optical power of the optical energy passing along the first YDF 212 and the second YDF 222. In some examples, the OPM 226 includes a tapping means (for example, a beam splitter, a WDM coupler, an optocoupler) for tapping optical radiation from the silica based glass optical fiber, a transducer for converting the tapped optical radiation into an electrical signal, and a display unit for displaying the amplified signal.

The OSA 228 is connected to the third isolator 224. The OSA 228 is configured to receive the amplified optical signal from the third isolator 224. The OSA 228 is configured to measure a frequency response of the received amplified optical signal. The OSA 228 is configured to measure the spectrum content of the received signal. The OSA 228 is further configured to measure and display the distribution of power of the signal laser over a specified wavelength span. In an aspect, the OSA 228 is configured to display power on the vertical scale and the wavelength on the horizontal scale.

In an aspect, a computing device is connected to the OSA 228 and the OPM 226. The computing device is configured to calculate a noise figure (NF) of the amplified optical signal from the calculated amplitude and frequency response of the amplified optical signal. The NF of an optical amplifier (e.g., a fiber amplifier or semiconductor optical amplifier) is a measure of how much excess noise the amplifier adds to the signal. More precisely, NF is a factor which indicates how much higher the noise power spectral density of the amplified output is when compared with the input noise power spectral density. In an example, the system 200 has a NF of 4 dB and a pump power conversion efficiency (PCE) of 60.5%.

The third isolator 224 may transmit or transfer the amplified laser beam to downstream components of an optical transmission system (may also include a computing device). The OSA 228, the computing device, and the OPM 226 may be configured as intermediary measuring devices which can be monitored by an operator. Measurements generated by the computing device may be transmitted to a remote station, for monitoring and error control.

In an aspect, the system 200 is configured to operate between 275 degrees Kelvin and 325 degrees Kelvin.

In an example, the system 200 has a signal attenuation of 0.1 dB. The system 200 is configured to yield a peak gain and output power of 62.5 dB and 4.5 W, respectively, at signal wavelength of 1.0329 μm.

The system 200 uses ytterbium ions as the gain medium. In an operative aspect, the system 200 is placed at an optical transmitter side to enhance the power level of the optical signals to be transmitted and to generate amplified optical signals as output. The system 200 is configured to amplify the signals so that the amplified (optical) signals can cover a large distance. Further, there may be various kinds of losses that occur in optical elements (for example, optical coupler, splitters, WDM multiplexers, and external optical modulators) between the laser and optical fibers. The system 200 is configured to amplify the optical signals such that the amplified optical signal is able to compensate for such losses.

The following experiments were conducted on the system 200 to verify its operation.

During experimentation, the system 200 (“also referred as YDFA 200”) was evaluated and stimulated using an optiSystem software tool (developed by Optiwave Systems Inc., located at 7 Capella Court, Suite 300, Ottawa, ON, Canada, K2E 8A7). The optiSystem enables a user to plan, test, and simulate (in both the time and frequency domain). The optiSystem has been used to simulate a high-performance optical amplifier by optimizing the Pr³⁺ doped fiber length and the pump power under optimized dopant concentration.

During the experiments, for developing a numerical model of the system 200, it is assumed that the amplified spontaneous emission (ASE) noise does not have significant power and the broadening in the gain medium is purely homogeneous. The different notations used in the numerical model of the system 200 are defined in table 1.

The excited and ground state populations may be expressed by the following carrier rate equations:

$$\frac{{dn}_{2}}{dt} = ( {R}_{12} + {W}_{12} ) {n}_{1} - ( {R}_{21} + {W}_{21} + {A}_{21} ) {n}_{2} . \qquad ( 1 )$$

$$\frac{{dn}_{1}}{dt} = ( {R}_{12} + {W}_{12} ) {n}_{1} - ( {R}_{21} + {W}_{21} + {A}_{21} ) {n}_{2} . \qquad ( 2 )$$

Under steady state conditions, the population of both the levels can be written as:

$${n}_{2} = \frac{{R}_{12} + {W}_{12}}{{R}_{12} + {R}_{21} + {W}_{12} + {W}_{21} + {A}_{21}} \qquad ( 3 )$$

$${n}_{1} = 1 - {n}_{2} \qquad ( 4 )$$

The transition rates between both the states may be written as:

$${R}_{12} = {σ}_{12}^{p} \frac{{I}_{p}}{{hv}_{p}} , {R}_{21} = {σ}_{21}^{p} \frac{{I}_{p}}{{hv}_{p}} \qquad ( 5 )$$

$${W}_{12} = {σ}_{12}^{s} \frac{{I}_{s}}{{hv}_{s}} , {W}_{21} = {σ}_{21}^{s} \frac{{I}_{s}}{{hv}_{s}} \qquad ( 6 )$$

It is known that a fraction of the pump power and the signal power may propagate in the undoped cladding of the YDF. Therefore, by introducing the overlap factors for the pump power and the signal power, the propagation equations of the pump power and the signal power at a given longitudinal position z along the fiber can be written as:

$$\frac{{dP}_{p}}{dz} = {η}_{p} ( {σ}_{21}^{p} {n}_{2} - {σ}_{12}^{p} {n}_{1} ) {n}_{t} {P}_{p} . \qquad ( 7 )$$

$$\frac{{dP}_{s}}{dz} = {η}_{s} ( {σ}_{21}^{s} {n}_{2} - {σ}_{12}^{s} {n}_{1} ) {n}_{t} {P}_{s} . \qquad ( 8 )$$

TABLE 1
Different symbols used in equations (1)-(8)

| Symbol | Description |
|---|---|
| Aᵢⱼ | Spontaneous decay rates between I and j levels |
| Wᵢⱼ | Stimulated emission rates between i and j levels |
| Rᵢⱼ | Pumping rates between i and j levels |
| n₁, n₂ | Population densities at ground and excited states |
| nₜ | Total population density |
| Iₚ, Iₛ | Pump and signal intensities |
| hvₚ, hvₛ | Pump and signal photon energies |
| σ₁₂^{p}, σ₂₁^{p} | Pump absorption and emission cross sections |
| σ₁₂^{s}, σ₂₁^{s} | Signal absorption and emission cross sections |
| z | Longitudinal position along fiber |
| Pₚ, Pₛ | Pump power and signal power |
| ηₚ, ηₛ | Pump overlap factor and signal overlap factor |

During experiments, an effect of using different pump powers during the first pumping stage 206 and the second pumping stage 216 on the NF of the system 200 is also investigated at different values of signal powers.

During the development of the system 200, the length of YDFs (the first YDF 212, the second YDF 222), the doping concentration of Yb³⁺ in the YDFs, and the pumping configuration were optimized with the help of signal wavelength versus gain plots.

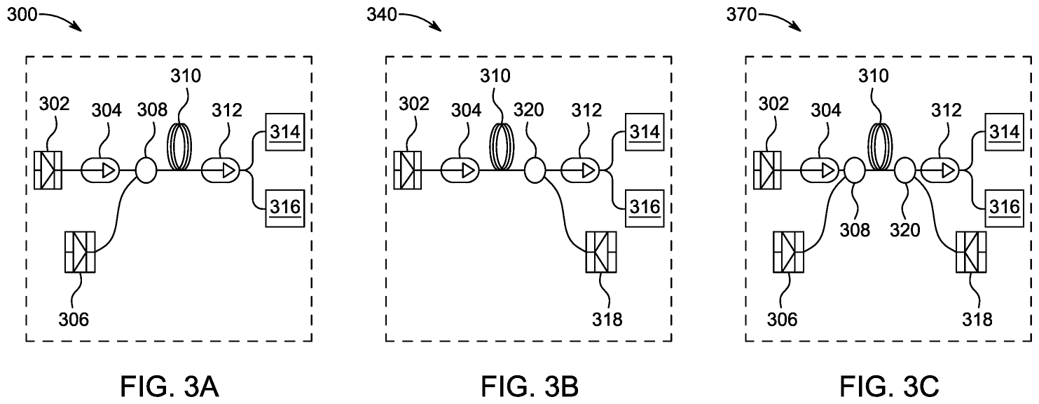

To validate the performance enhancement of the YDFA achieved through the system 200, the performance of the YDFA was characterized by employing conventional pumping schemes such as a forward pumping configuration, a backward pumping configuration, and a bidirectional pumping configuration. In a first stage of the experiments, to generate a set of benchmarks for testing the performance of the system 200, different pumping configurations of a conventional YDFA were simulated. FIG. 3A-FIG. 3C show the different pumping configurations of the conventional YDFA. The conventional YDFA includes a signal laser 302, a first optical isolator 304, a pump 306, a coupler 308, an YDF 310, a second optical isolator 312, an optical power meter 314, an optical spectrum analyzer (OSA) 316, a pump 318, and a coupler 320.

The length of YDF, the doping concentration of Yb³⁺, and the pumping configurations are three important factors that typically affect the performance of a doped fiber amplifier. Therefore, these factors are required to regulate for achieving a defined performance of the YDFA and were also used as a benchmark to observe the performance of the system 200.

FIG. 3A-FIG. 3C demonstrate the conventional YDFA where different conventional pumping configurations are used to excite the gain medium of the YDF.

The signal laser 302 is configured to generate a signal laser beam.

The first optical isolator 304 is connected to the signal laser 302. The first optical isolator 304 is configured to receive the generated signal laser beam from the signal laser 302 and generates an isolated signal laser beam. The first optical isolator 304 is configured to transmit the signal laser beam to the coupler 308 and prevent the signal laser beam from reflecting back into the signal laser 302.

The pump 306 is configured to generate a pumped laser beam. The pump 306 is configured to transfer energy from an external source into a gain medium of the YDFA.

The coupler 308 is connected to the first optical isolator 304 and the pump 306. The coupler 308 is configured to receive the isolated signal laser beam from the first optical isolator 304 and the pumped laser beam from the pump 306 simultaneously. The coupler 308 is configured to combine the received signal laser beam and the pumped laser beam and generate a combined laser beam.

The YDF 310 is configured to receive the combined laser beam from the coupler 308. The YDF 310 is configured to amplify photons in the received laser beam and to generate an amplified laser beam.

The second optical isolator 312 is configured to receive the amplified laser beam from the YDF 310. The second optical isolator 312 generates an isolated amplified laser beam. The second optical isolator 312 is configured to ensure unidirectional operation of the amplified laser beam. The second optical isolator 312 is configured to transmit the amplified laser beam to the OSA 316 and the optical power meter 314.

The optical power meter 314 is commutatively connected to the second optical isolator 312 and receives the isolated amplified laser beam from the second optical isolator 312. The optical power meter 314 is configured to measure an amplitude of the received amplified laser beam.

The OSA 316 is connected to the second optical isolator 312. The OSA 316 is configured to receive the isolated amplified laser beam from the second optical isolator 312. The OSA 316 is configured to measure a frequency response of the received amplified laser beam. The OSA 316 is configured to measure the spectrum content of the received laser beam.

The pump 318 is configured to generate a pumped laser beam.

The coupler 320 is connected to the YDF 310 and the pump 318. The coupler 320 is configured to simultaneously receive the amplified laser beam from the YDF 310 and the pumped laser beam from the pump 318. The coupler 320 is configured to combine the received amplified signal laser beam and the pumped laser beam and generate a combined laser beam.

FIG. 3A represents a forward pumping configuration 300 to excite the gain medium of the conventional YDFA. In the forward pumping configuration 300, the pump 306 and the signal laser beam generated by the signal laser 302 co-propagate through the YDF 310.

FIG. 3B represents a backward pumping configuration 340 of the conventional YDFA. In the backward pumping configuration 340, the pump 318 and the signal laser beam generated by the signal laser 302 counter propagate through the YDF 310.

FIG. 3C represents a bidirectional pumping configuration 370 of the conventional YDFA. In the bidirectional pumping configuration 370, both pumps (306, 318) are used for pumping the gain medium from both ends of the YDF 310.

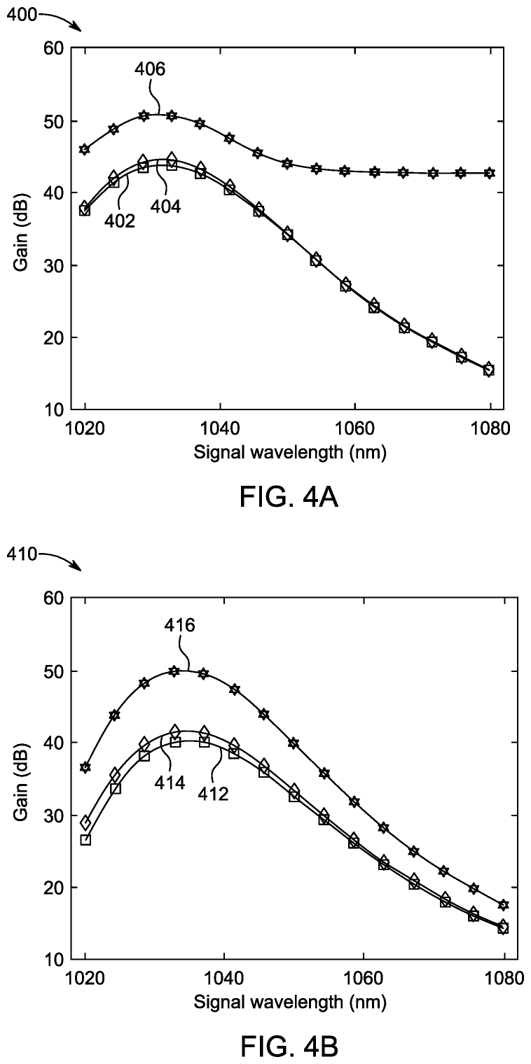

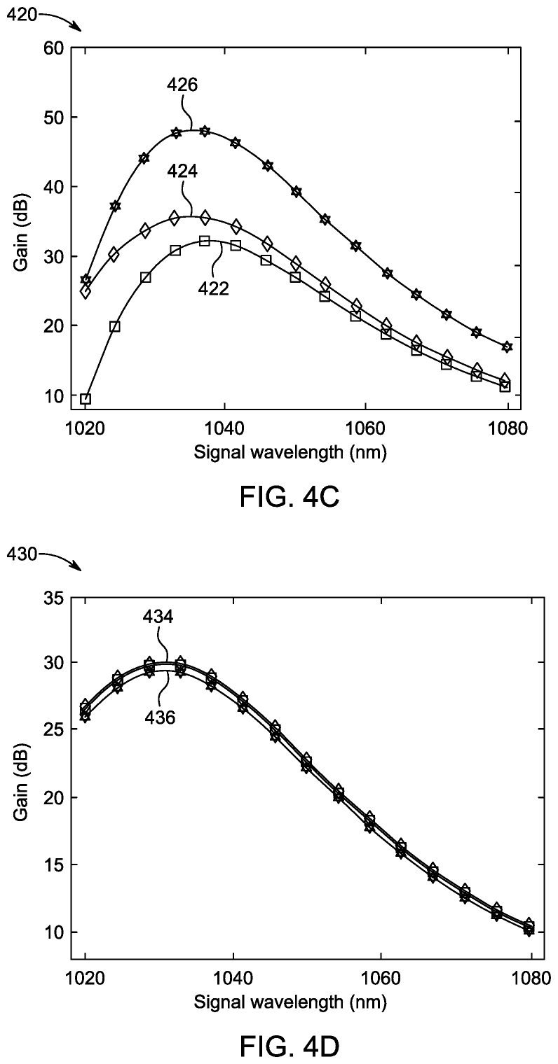

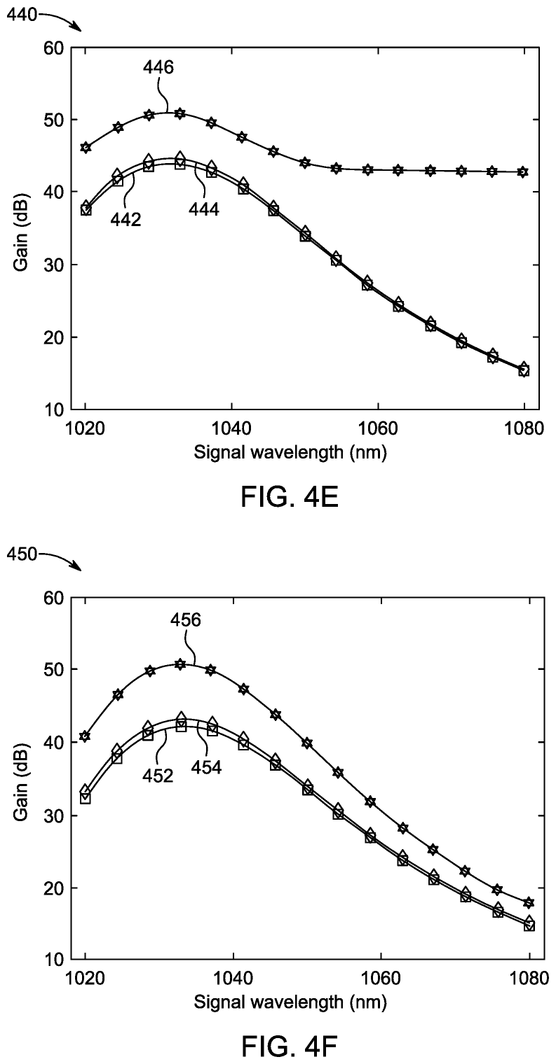

By keeping the total pump power and the doping concentration (Yb³⁺ concentration) fixed at 5 W and 50×10²⁴ m⁻³ for all three cases (the forward pumping configuration 300, the backward pumping configuration 340, and the bidirectional pumping configuration 370), the signal wavelength versus gain of the conventional YDFA plots were obtained at different lengths (2.5 m, 5 m, and 7.5 m) of the YDF 310, as shown in FIG. 4A-FIG. 4C, respectively.

FIG. 4A is a graph 400 illustrating the gain of the conventional YDFA when the length of the YDF=2.5 m, and the total pump power and the doping concentration are fixed. Curve 402 illustrates gain of the conventional YDFA in the forward pumping configuration when the length of the YDF=2.5 m. Curve 404 illustrates gain of the conventional YDFA in the backward pumping configuration when the length of the YDF=2.5 m. Curve 406 illustrates gain of the conventional YDFA in the bidirectional pumping configuration when the length of the YDF=2.5 m.

FIG. 4B is a graph 410 illustrating the gain of the conventional YDFA when the length of the YDF=5 m and the total pump power and the doping concentration are fixed. Curve 412 illustrates gain of the conventional YDFA in the forward pumping configuration when the length of the YDF=5 m. Curve 414 illustrates gain of the conventional YDFA in the backward pumping configuration when the length of the YDF=5 m. Curve 416 illustrates gain of the conventional YDFA in the bidirectional pumping configuration when the length of the YDF=5 m.

FIG. 4C is a graph 420 illustrating the gain of the conventional YDFA when the length of the YDF=7.5 m, and the total pump power and the doping concentration are fixed. Curve 422 illustrates gain of the conventional YDFA in the forward pumping configuration when the length of the YDF=7.5 m. Curve 424 illustrates gain of the conventional YDFA in the backward pumping configuration when the length of the YDF=7.5 m. Curve 426 illustrates gain of the conventional YDFA in the bidirectional pumping configuration when the length of the YDF=7.5 m.

By keeping the total pump power and optimized length of the YDF fixed at 5 W and 2.5 m, respectively, for all three cases, signal wavelength versus gain plots are obtained at doping concentrations of 25×10²⁴ m⁻³, 50×10²⁴ m⁻³ and 75×10²⁴ m⁻³, as shown in FIG. 4D-FIG. 4F, respectively.

FIG. 4D is a graph 430 illustrating the gain of the conventional YDFA when the doping concentration=25×10²⁴ m⁻³, and the total pump power and the length of the YDF are fixed. Curve 434 illustrates gain of the conventional YDFA in the backward pumping configuration and the forward pumping configuration when the doping concentration=25×10²⁴ m⁻³. Curve 436 illustrates gain of the conventional YDFA in the bidirectional pumping configuration when the doping concentration=25×10²⁴ m⁻³.

FIG. 4E is a graph 440 illustrating the gain of the conventional YDFA when the doping concentration=50×10²⁴ m⁻³, and the total pump power and the length of the YDF are fixed. Curve 442 illustrates gain of the conventional YDFA in the forward pumping configuration when the doping concentration=50×10²⁴ m⁻³. Curve 444 illustrates gain of the conventional YDFA in the backward pumping configuration when the doping concentration=50×10²⁴ m⁻³. Curve 446 illustrates gain of the conventional YDFA in the bidirectional pumping configuration when the length of the doping concentration=50×10²⁴ m⁻³.

FIG. 4F is a graph 450 illustrating the gain of the conventional YDFA when the doping concentration=75×10²⁴ m⁻³, and the total pump power and the length of the YDF are fixed. Curve 452 illustrates gain of the conventional YDFA in the forward pumping configuration when the doping concentration=75×10²⁴ m⁻³. Curve 454 illustrates gain of the conventional YDFA in the backward pumping configuration when the doping concentration=75×10²⁴ m⁻³. Curve 456 illustrates gain of the conventional YDFA in the bidirectional pumping configuration when the length of the doping concentration=75×10²⁴ m⁻³.

It may be observed from FIG. 4A-FIG. 4F that, in the bidirectional pumping configuration, a peak gain of 51 dB at a signal wavelength of 1.0329 μm was achieved for 2.5 m YDF that has the doping concentration of 75×10²⁴ m⁻³. During experiments, this value of peak gain of the conventional YDFA was considered the benchmark against which the systems (200) performance was compared.

During a second stage of developing the system 200, the pumping arrangements employed in the system 200 are based on the fact that the gain and the power level of the optical signal at the output of the first pumping stage 206 play a significant role in minimizing or maximizing the peak gain, power, and NF of the output of the second pumping stage 216. Therefore, to optimize the gain and power level of the signal at the output of the first pumping stage 206, by employing dual-stage in-band asymmetrical pumping. From FIG. 1A, it may be observed from the absorption spectra and the emission spectra of Yb³⁺, that there are two pump absorption peaks. A first absorption peak is centered around 0.92 μm, while a second absorption peak is centered around 0.975 μm. The absorption cross section of 0.92 μm is smaller compared to 0.975 μm. In the system 200, the gain medium of the first pumping stage 206, which is a short piece of YDF 212 having a length of 1 m and Yb³⁺ concentration of 50×10²⁴ m⁻³ is excited through the pump 208 having 1 W of power at a wavelength of 0.92 μm, where the absorption of the pump photons is lower. As a result, the gain medium experiences low population inversion and stimulated emission. Consequently, a limited rise is achieved for the gain, optical power, and ASE of the signal at the output of the first pumping stage which is given as the input to the second pumping stage 216. In the same way, the gain medium of the second pumping stage 216, whose length is greater than the gain medium of the first pumping stage 206, having the same Yb³⁺ concentration, is excited through the pump 218 of 4 W having a wavelength of 0.98 μm, where the absorption of the pump photons is maximum. In this way, the gain medium of the second pumping stage 216 experiences maximum population inversion and stimulated emission, resulting in peak gain of the amplifier at the output of the second pumping stage with limited ASE. As the rise of the ASE of the YDFA 200 at the output of the second pumping stage 216 is controlled through low power pumping of the first pumping stage 206 at a wavelength where the absorption of the pump photons is low, the NF of the YDFA 200 is reduced significantly. In the system 200, enhanced performance is achieved without using any optical component between the two pumping stages.

The first YDF 212 and the second YDF 222 are the most critical components in the system design, and their parameters are shown in table 2. For example, the first YDF 212 and the second YDF 222 are YDF Model #YB1200-4/125 (manufactured by Thorlabs Inc. located at 43 Sparta Ave, Newton, NJ 07860).

To evaluate the performance of the system 200, various parameters such as the fiber length, doping concentration, pump power, signal power, core diameter, numerical aperture (NA), and signal attenuation were measured and analyzed. All measured and analyzed parameters are summarized in table 2.

TABLE 2
Details of important parameters

| Parameter | Value | |
|---|---|---|
| Wavelength of the first pump | 0.92 | μm |
| Wavelength of the second pump | 0.98 | μm |
| Power of the first pump | 1 | W |
| Power of the second pump | 4 | W |
| Length of the first YDF | 1 | m |
| Yb³⁺ concentration in the first YDF | 50 × 10²⁴ | m⁻³ |
| Core radius of the first YDF and the second YDF | 3.4 | μm |
| Doping radius of the first YDF and the second YDF | 2.4 | μm |
| Cladding radius of the first YDF and the second YDF | 62.5 | μm |
| Numerical aperture of core of the first YDF and the | 0.2 | |
| second YDF | | |
| Numerical aperture of cladding of the first YDF | 0.5 | |
| and the second YDF | | |
| Signal attenuation | 0.1 | dB |
| Pump attenuation | 0.15 | dB |
| Temperature | 300 | K |

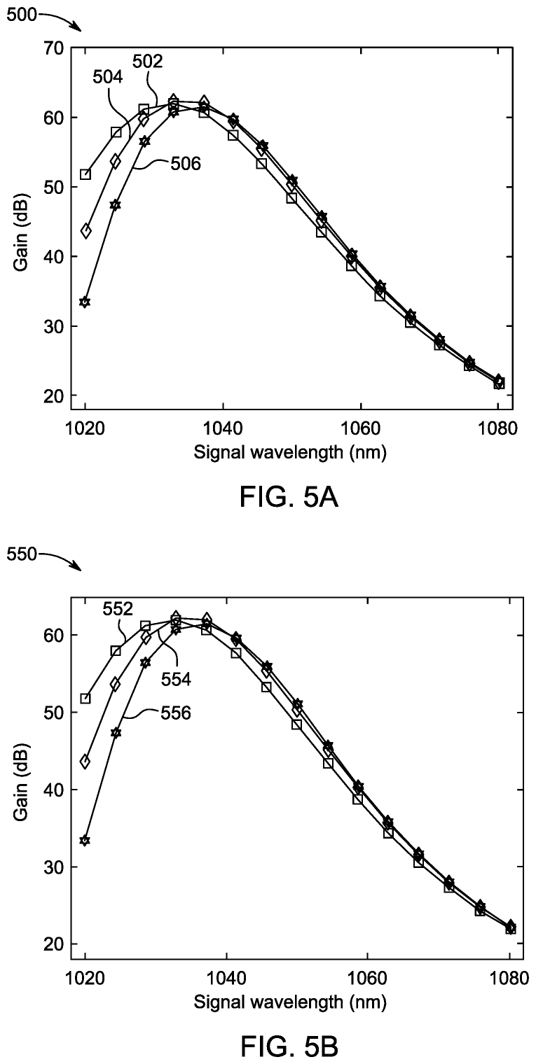

To optimize the performance of the system 200, the length and doping concentration of Yb³⁺ in the second YDF 222 needs to be optimized while keeping the power of first pump 208 and the length and doping concentration of the first YDF 212 fixed at 1 w, 1 m, and 50×10²⁴ m⁻³, respectively. The peak gain of the system 200 is observed by varying the signal wavelength in a range of 1.02 μm-1.08 μm for different lengths of the second YDF 222 (as shown in FIG. 5A) and different doping concentration of Yb³⁺ in the second YDF 222 (as shown in FIG. 5B).

FIG. 5A is a graph 500 illustrating signal wavelength versus gain of the system 200 at different lengths of the second YDF 222. Curve 502 illustrates gain of the system 200 when the length of second YDF 222 is 3 m. Curve 504 illustrates gain of the system 200 when the length of second YDF 222 is 6 m. Curve 506 illustrates gain of the system 200 when the length of second YDF 222 is 9 m.

The power of the signal and second pump 218 is kept at −35 dBm and 4 W, respectively. It may be observed from FIG. 5A that a peak gain of around 62 dB, 62.5 dB, and 60.8 dB is observed at 3 m, 6 m, and 9 m lengths of the second YDF 222, respectively, for the signal wavelength of 1.0329 μm. The peak gain reduces on increasing the length beyond 6 m which is due to a decrease in population inversion inside the gain medium.

FIG. 5B is a graph 550 illustrating signal wavelength versus gain of the system 200 at different doping concentrations of Yb³⁺. Curve 552 illustrates gain of the system 200 when the doping concentrations of Yb³⁺ is 25×10²⁴ m⁻³. Curve 554 illustrates gain of the system 200 when the doping concentrations of Yb³⁺ is 50×10²⁴ m⁻³. Curve 556 illustrates gain of the system 200 when the doping concentrations of Yb³⁺ is 75×10²⁴ m⁻³.

FIG. 5B shows that a peak gain of 62.02 dB, 62.5 dB, and 60.5 dB is obtained at Yb³⁺ doping concentrations of 25×10²⁴ m⁻³, 50×10²⁴ m⁻³, and 75×10²⁴ m⁻³, respectively, for a signal wavelength of 1.0329 μm at the optimized length of the second YDF. Therefore, a length of 6 m and a Yb³⁺ doping concentration of 50×10²⁴ m⁻³ yield the highest peak gain of 62.5 dB. The recorded peak gain of 62.5 dB is higher by 11.5 dB than the benchmark at the same conditions.

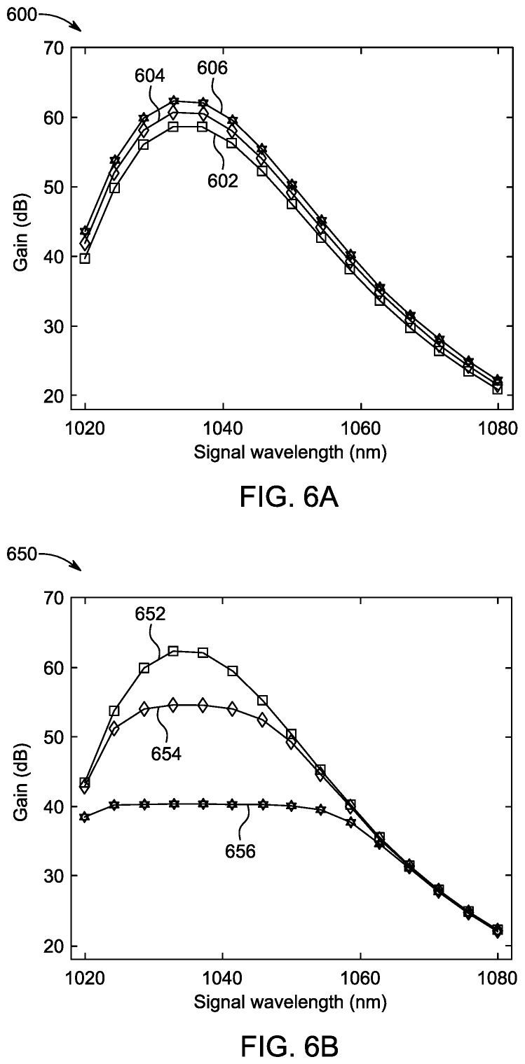

FIG. 6A-FIG. 6B show signal wavelength versus gain plots at different values of the pump power and the signal power at optimized parameters. FIG. 6A is a graph 600 illustrating signal wavelength versus gain of the system 200 at different pump powers. Curve 602 illustrates gain of the system 200 when the pump power is 2 W. Curve 604 illustrates gain of the system 200 when the pump power is 3 W. Curve 606 illustrates gain of the system 200 when the pump power is 4 W.

FIG. 6B is a graph 650 illustrating signal wavelength versus gain at different signal powers. Curve 652 illustrates gain of the system 200 when the signal power is −35 dBm. Curve 654 illustrates gain of the system 200 when the signal power is −20 dBm. Curve 656 illustrates gain of the system 200 when the signal power is −5 dBm.

It may be observed from FIG. 6A that peak gains of around 58.6 dB, 60.6 dB, and 62.5 dB have been obtained at pump powers of 2 W, 3 W, and 4 W, respectively, for the signal wavelength of 1.0329 μm. Similarly, peak gains of 62.5 dB, 54.5 dB, and 40.4 dB have been observed for signal powers of −35 dBm, −20 dBm, and −5 dBm, respectively, for the signal wavelength of 1.0329 μm.

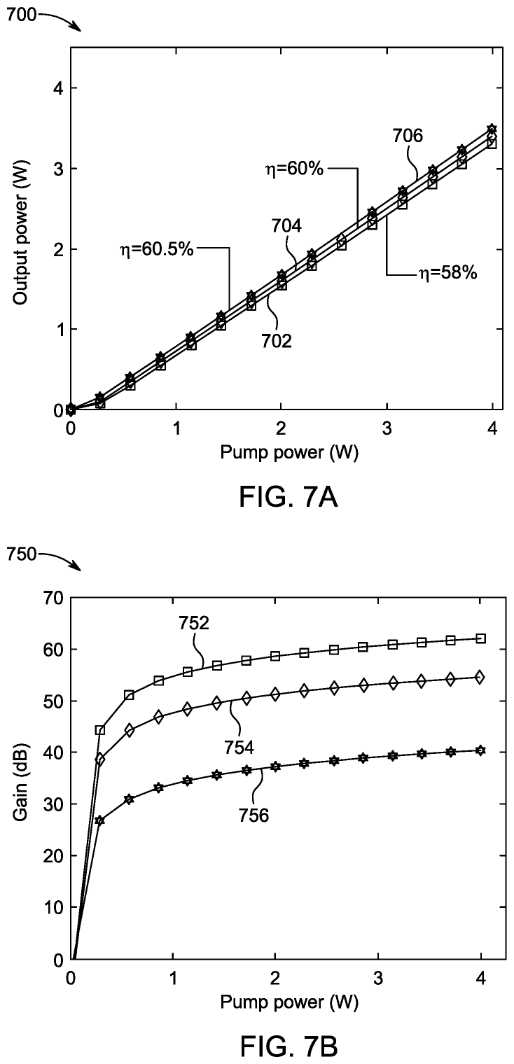

FIG. 7A-FIG. 7B show pump power versus output power and gain of the system 200 at defined parameters at different values of signal power.

FIG. 7A is a graph 700 illustrating pump power versus output power of the system 200 at different values of signal power. Curve 702 illustrates the output power of the system 200 when the signal power is −35 dBm. Curve 704 illustrates the output power of the system 200 when the signal power is −20 dBm. Curve 706 illustrates the output power of the system 200 when the signal power is −5 dBm. It may be observed from FIG. 7A that PCEs of 58.8%, 60%, and 60.5% are obtained for signal powers of −35 dBm, −20 dBm, and −5 dBm, respectively, and the signal wavelength of 1.0329 μm.

FIG. 7B is a graph 750 illustrating pump power versus gain of the system 200 at different values of signal power. Curve 752 illustrates the gain of the system 200 when the signal power is −35 dBm. Curve 754 illustrates the gain of the system 200 when the signal power is −20 dBm. Curve 756 illustrates the gain of the system 200 when the signal power is −5 dBm.

As shown in FIG. 7B, the gain is almost zero when the pump power is 0 W at different values of signal power, because lasting action (excitation of the electrons in the gain medium) does not occur in the absence of the pump power. The gain quickly increases on increasing the pump power for each value of signal power; however, the highest gain is achieved for the signal power of −35 dBm.

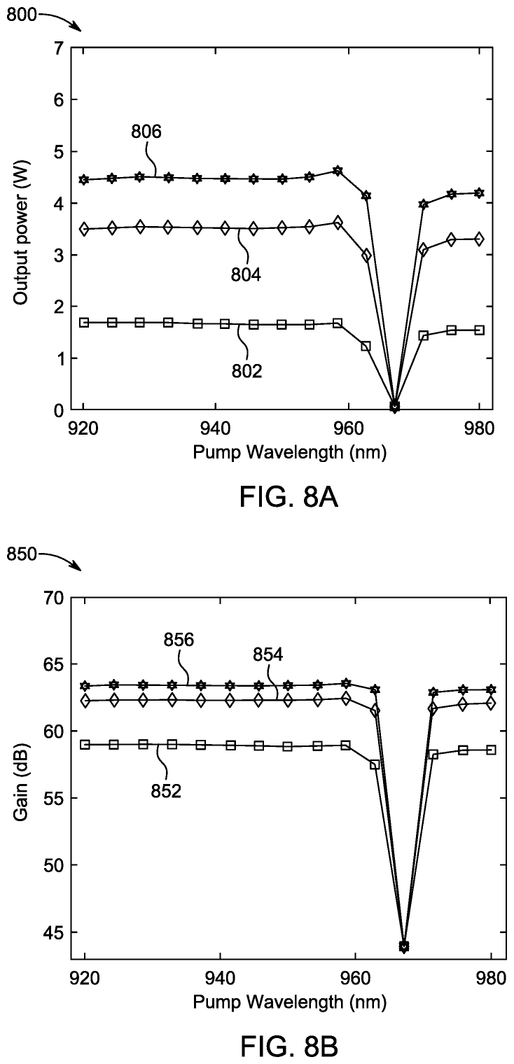

FIG. 8A-FIG. 8B show the impact of pump wavelength variation on the output power and gain of the system 200 for three different values of pump power at the signal wavelength of 1.0329 μm.

FIG. 8A is a graph 800 illustrating pump wavelength versus output power of the system 200 at different values of signal power. Curve 802 illustrates the output power of the system 200 when the pump power is 2 W. Curve 804 illustrates the output power of the system 200 when the pump power is 4 W. Curve 806 illustrates the output power of the system 200 when the pump power is 6 W.

FIG. 8B is a graph 850 illustrating pump wavelength versus gain of the system 200 at different values of signal power. Curve 852 illustrates the gain of the system 200 when the pump power is 2 W. Curve 854 illustrates the gain of the system 200 when the pump power is 4 W. Curve 856 illustrates the gain of the system 200 when the pump power is 6 W.

It can be observed from FIG. 8A that the output power of the system 200 remains stable around 1.75 W, 3.5 W, and 4.5 W for pump powers of 2 W, 4 W, and 6 W, respectively, while varying the pump wavelength from 0.940 μm to 0.960 μm. For the same range of pump wavelength, the gain of the system 200 is around 59 dB, 62.5 dB, and 63.5 dB for pump powers of 2 W, 4 W, and 6 W, respectively, as shown in FIG. 8B. The output power and gain of the system (graph 800) show a sharp dip at around 0.965 μm for each value of pump power. For the pump wavelength beyond 0.965 μm, the graph 800 approximately retains its previous pattern. This particular behavior may be understood from FIG. 1A, where it can be observed that the absorption of the pump photons is almost the same in the 0.940-0.960 μm wavelength range. Therefore, the output power and gain remain stable in this wavelength range for all three values of pump powers. FIG. 1A shows a sharp absorption peak around 0.965 μm where absorption of pump photons is highest. The highest absorption of the pump photons at around 0.965 μm at high pump powers saturates the amplifier, resulting in an interim decrease in stimulated emission. At this point, the output power and gain of the amplifier suddenly decreases. This saturation state exists until the absorption of pump photons is reduced, bringing the output power and gain to their previous values.

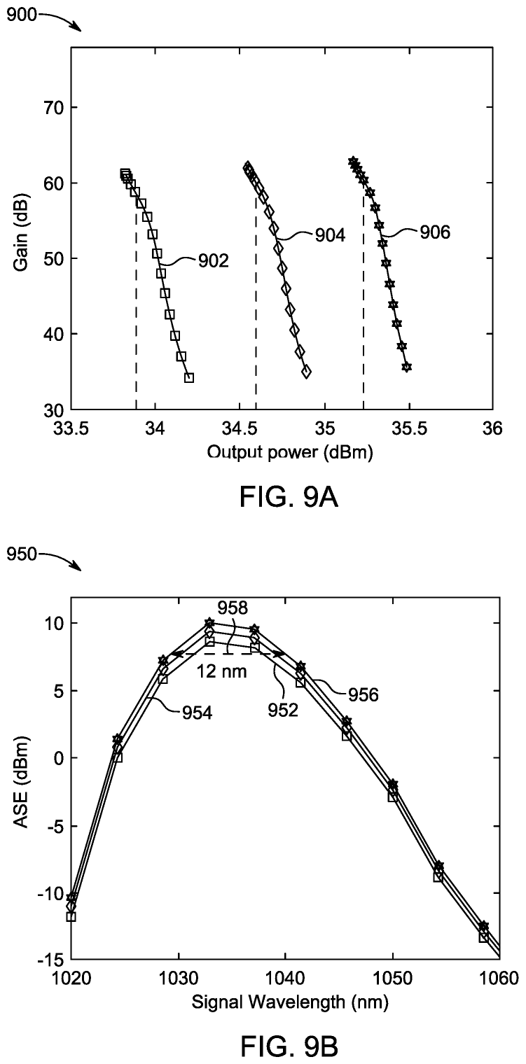

FIG. 9A is a graph 900 illustrating output power versus gain of the system 200 as a function of pump power, when the signal power is kept at −35 dBm. Curve 902 illustrates the gain of the system 200 when the pump power is 3 W. Curve 904 illustrates the gain of the system 200 when the pump power is 3.5 W. Curve 906 illustrates the gain of the system 200 when the pump power is 4 W. It may be observed from FIG. 9A that 3 dB gain saturation is obtained at output powers of 33.9 dBm, 34.6 dBm, and 35.3 dBm for pump powers of 3 W, 3.5 W, and 4 W, respectively, at optimized parameters for the signal wavelength of 1.0329 μm.

FIG. 9B is a graph 950 illustrating signal wavelength versus ASE power of the system 200 as a function of pump power when the signal power is kept at −35 dBm. Curve 952 illustrates the ASE of the system 200 when the pump power is 3 W. Curve 954 illustrates the ASE of the system 200 when the pump power is 3.5 W. Curve 956 illustrates the ASE of the system 200 when the pump power is 4 W.

A peak ASE power of 8.7 dBm is observed at the signal wavelength of 1.0329 μm for pump power of 3 W. The ASE power peaks to 9.4 dBm and 10.1 dBm for pump powers of 3.5 W and 4 W, respectively. The peak ASE power increases with the pump power because an increase in pump power not only increases the stimulated emission but also the spontaneous emission. Moreover, a 3 dB bandwidth of 12 nm is obtained for pump power of 4 W, as shown by line 958 in FIG. 9B.

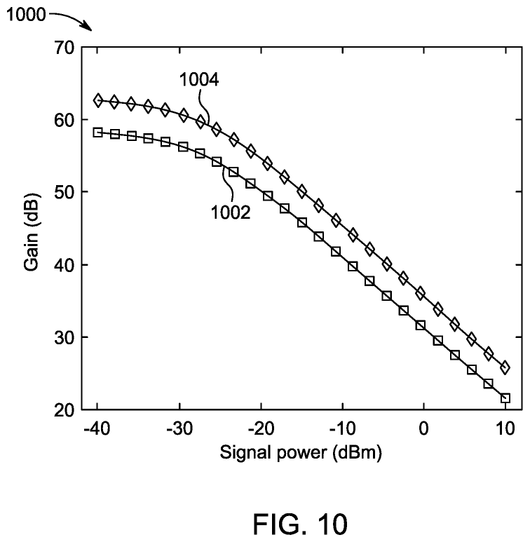

To demonstrate the gain saturation, the signal power versus gain of the system 200 as a function of pump power at optimized parameters for a signal wavelength of 1.0329 μm is shown in FIG. 10.

FIG. 10 is a graph 1000 illustrating signal power versus gain of the system 200 as a function of pump power. Curve 1002 illustrates gain of the system 200 when the pump power is 2 W. Curve 1004 illustrates gain of the system 200 when the pump power is 4 W. It may be observed that the gain gradually increases on decreasing the signal power up to −30 dBm from 10 dBm for both levels of pump power. On further decreasing the signal power beyond −30 dBm up to −40 dBm, the gain saturates and stops increasing further for both values of pump power. Moreover, it may also be observed that the gain is higher at a high value of pump power.

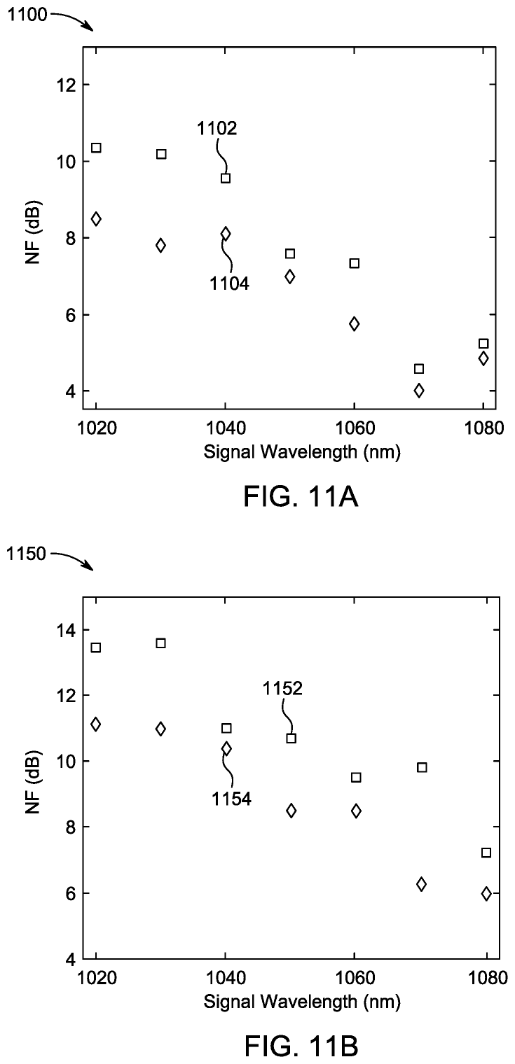

FIG. 11A is a graph 1100 illustrating the signal wavelength versus noise figure (NF) of the system 200 as a function of signal power when the power of the first pump 208 is 1 W, and the power of the second pump 218 is 4 W. Square objects 1102 represent the NF of the system 200 when the signal power is −35 dBm. Diamond objects 1104 represent the NF of the system 200 when the signal power is −5 dBm.

The NF of the system 200 has been evaluated for signal wavelengths between 1.020 μm and 1.080 μm and at signal powers of −35 dBm and −5 dBm, as shown in FIG. 11A. At a signal wavelength of 1.070 μm, minimum values of NF of 4.6 dB and 4 dB are observed for signal power of −35 dBm and −5 dBm, respectively. Generally, the optical signal-to-noise ratio (OSNR) of the amplified signal deteriorates during the process of amplification as a result of ASE that increases rapidly when the signal power is low. This is the reason behind low values of NF for the 1.020 μm to 1.080 μm wavelength range for signal power of −5 dBm as compared to signal power of −35 dBm.

To investigate the effect of using high and low pump powers at the first pumping stage 206 and the second pumping stage 216 on the NF of the system 200, the powers of first pump 208 and second pump 218 are chosen as 4 W and 1 W, respectively, while keeping the length and doping concentration of Yb³⁺ in the first YDF 212 and the second YDF 222 constant. FIG. 11B is a graph 1150 illustrating signal wavelength versus NF of the system 200 as a function of signal power when the power of the first pump 208 is 4 W, and the power of the second pump 218 is 1 W. The length of the first YDF 212 and the second YDF 222 are taken as 1 m and 6 m, respectively, and the Yb³⁺ concentration of both the first YDF 212 and the second YDF 222 are chosen as 50×10²⁴ m⁻³. Square objects 1152 represent the NF of the system 200 when the signal power is −35 dBm. Diamond objects 1154 represent the NF of the system 200 when the signal power is −5 dBm.

It may be observed from FIG. 11B that the NF of the system 200 has increased compared to FIG. 11A after adjusting the powers of first pump 208 and second pump 218 as 4 W and 1 W for signal powers of −35 dBm and −5 dBm, respectively. Therefore, minimum values of the NF of 10 dB and 6.3 dB are observed at a signal wavelength of 1.070 μm for signal powers of −35 dBm and −5 dBm, respectively. The reason behind this trend is that pumping the first YDF 212 with a high power of 4 W generates an excessive amount of ASE at the output of the first pumping stage despite using the pump wavelength of 0.92 μm, where the absorption of the pump photons is lower. The second YDF 222 in the second pumping stage is pumped by a significantly lower power of 1 W compared to the first pumping stage pumping. Apparently, the difference in generation of ASE at the output of the second pumping stage should not be high because maximum amplification and ASE generation have already been achieved at the first stage. Since the pump wavelength of 0.980 μm, where the absorption of the pump photons is highest, generates more ASE than expected despite the low pump power, there is an increase in the NF of the system 200.

The performance of the system 200 is compared with the aforementioned existing amplifiers and is summarized in table 3. It is observed from the table 3 that the system 200 is efficient in comparison to conventional optical amplifiers.

TABLE 3
Summary of performance comparison

| | Pumping | | | Output | | |
|---|---|---|---|---|---|---|
| Study | Stages | Pumps | Gain | Power | NF | PCE |
| Aleshkina et al. | Single | 1 | — | 100 mW | — | 11.5% |
| Liu, Y et al. | Single | 2 | 45 dB | — | — | |
| Liu et al. | Dual | 2 | 21 dB | — | — | |
| M. Sajjad et al. | Dual | 2 | 25.5 dB | — | — | |
| Y. Yu et al. | Single | 1 | — | 6.7 W | — | 38% |
| Mohammed | Single with | 1 | 25 dB | — | 3.5 dB | — |
| et al. | dual pass | | | | | |
| Conventional | Single | 1 | 32 dB | 0.2 W | 4 dB | — |
| Thor amplifier | | | | | | |
| The system 200 | Dual | 2 | 62.5 dB | 3.5 W | 4 dB | 60.5% |

In an operational aspect, the present disclosure enhances the performance of the YDFA for use in various applications of optical communications in the 1.02 μm-1.08 μm spectral range based on the dual-stage in-band asymmetrical pumping arrangement. The pumping arrangement includes two co-propagating forward pumps. The gain medium of the first pumping stage is pumped using a wavelength for which photon absorption is low. The gain medium of the second pumping stage is pumped using the wavelength for which photon absorption is maximum. The pump power of the first pumping stage is kept to a minimum compared to the second stage. Without using any optical component between the two pumping stages, the system 200 is configured to achieve a high peak gain of 62.5 dB and high peak output power. Furthermore, the value of NF can be scaled simply by varying the pumping wavelength and power of the first stage at the cost of a reduction in peak gain and output power of YDFA. A minimum value for NF of 4 dB has been observed for a signal wavelength of 1.070 μm.

The first embodiment is illustrated with respect to FIG. 2. The first embodiment describes the system 200 for amplifying optical signals. The system 200 includes a first isolator 204 configured to receive an input signal and convert the input signal into a first isolated signal, a first pump 208 configured to generate first pump photons, a first coupler 210 configured to receive and join the first isolated signal and the first pump photons into a first pumped signal, a first YDF 212 configured to receive the first pumped signal and convert the first pumped signal to a first amplified signal, a second isolator 214 configured to receive the first amplified signal and convert the first amplified signal into a second isolated signal, a second pump 218 configured to generate second pump photons, a second coupler 220 configured to receive and join the second isolated signal and the second pump photons into a second pumped signal, a second YDF 222 configured to receive the second pumped signal and convert the second pumped signal into a second amplified signal, and a third isolator 224 configured to receive the second amplified signal and convert the second amplified signal into an amplified optical signal. The first pump 208 and the second pump 218 are configured as co-propagating in-band asymmetrical pump sources for the first and second photons.

In an aspect, the first YDF 212 has a length of 1 meter and a Yb³⁺ concentration of 50×10²⁴ m⁻³.

In an aspect, the second YDF 222 has a length of 6 meters and a Yb³⁺ concentration of 50×10²⁴ m⁻³.

In an aspect, the first pump 208 is operated at a wavelength of 0.92 μm and a power of 1 Watt.

In an aspect, the second pump 218 is operated at a wavelength of 0.98 μm and a power of 4 Watts.

In an aspect, the input signal is between 1.02 μm and 1.08 μm.

In an aspect, the first YDF 212 has a first gain medium excitation wavelength, and the second YDF has a second gain medium excitation wavelength.

In an aspect, the first gain medium excitation wavelength is lower than the second gain medium excitation wavelength.

In an aspect, the first gain medium excitation wavelength is at a minimum with respect to the second gain medium excitation wavelength and the second gain medium excitation wavelength is at a maximum with respect to the first gain medium excitation wavelength.

In an aspect, the first YDF 212 has a core radius of 3.4 μm and the second YDF has a core radius of 3.4 μm.

In an aspect, the first YDF 212 has a doping radius of 2.4 μm and the second YDF has a doping radius of 2.4 μm.

In an aspect, the system 200 is operated between 275 degrees Kelvin and 325 degrees Kelvin.

In an aspect, the system 200 has a signal attenuation of 0.1 dB.

In an aspect, the first pump 208 has a signal attenuation of 0.15 dB and the second pump 218 has a signal attenuation of 0.15 dB.

In an aspect, the first YDF 212 has a cladding radius of 62.5 μm and the second YDF 222 has a cladding radius of 62.5 μm.

In an aspect, the first pump 208 is operated at a power between 2 Watts and 6 Watts, and the second pump 218 is operated at a power between 2 Watts and 6 Watts.

The second embodiment is illustrated with respect to FIG. 2. The second embodiment describes the system 200 for amplifying optical signals. The system 200 includes a first isolator configured to receive an input signal and convert the input signal into a first isolated signal, a first pump 208 configured to generate first pump photons, a first coupler 210 configured to receive and join the first isolated signal and the first pump photons into a first pumped signal, a first gain medium configured to receive the first pumped signal and convert the first pumped signal to a first amplified signal, a second isolator 214 configured to receive the first amplified signal and convert the first amplified signal into a second isolated signal, a second pump 218 configured to generate second pump photons, a second coupler 220 configured to receive and join the second isolated signal and the second pump photons into a second pumped signal, a second gain medium configured to receive the second pumped signal and convert the second pumped signal into a second amplified signal, and a third isolator 224 configured to receive the second amplified signal and convert the second amplified signal into an amplified optical signal. The first gain medium is excited using a wavelength with a lower photon absorption rate than the second gain medium. The first pump 208 is operated at a minimum power with respect to the power at which the second pump 218 is operated.

In an aspect, the first gain medium is a first YDF. The first YDF having a length of 1 meter and a Yb³⁺ concentration of 50×10²⁴ m⁻³.

In an aspect, the second gain medium is a second YDF. The second YDF having a length of 6 meters and a Yb³⁺ concentration of 50×10²⁴ m⁻³.

In an aspect, the input signal is between 1.02 μm and 1.08 μm.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A system for amplifying optical signals, the system comprising:
a first isolator configured to receive an input signal and convert the input signal into a first isolated signal;
a first pump configured to generate first pump photons;
a first coupler configured to receive and join the first isolated signal and the first pump photons into a first pumped signal;
a first ytterbium doped fiber configured to receive the first pumped signal and convert the first pumped signal to a first amplified signal;
a second isolator configured to receive the first amplified signal and convert the first amplified signal into a second isolated signal;
a second pump configured to generate second pump photons;
a second coupler configured to receive and join the second isolated signal and the second pump photons into a second pumped signal;
a second ytterbium doped fiber configured to receive the second pumped signal and convert the second pumped signal into a second amplified signal; and
a third isolator configured to receive the second amplified signal and convert the second amplified signal into an amplified optical signal;
wherein the first pump and second pump are configured as co-propagating in-band asymmetrical pump sources for the first and second photons.

2. The system of claim 1, wherein the first ytterbium doped fiber has a length of about 1 meter and a Yb³⁺ concentration of about 50×10²⁴ m⁻³.

3. The system of claim 1, wherein the second ytterbium doped fiber has a length of about 6 meters and a Yb³⁺ concentration of about 50×10²⁴ m⁻³.

4. The system of claim 1, wherein the first pump is operated at a wavelength of about 0.92 μm and a power of about 1 Watt.

5. The system of claim 1, wherein the second pump is operated at a wavelength of about 0.98 μm and a power of about 4 Watts.

6. The system of claim 1, wherein the input signal is between 1.02 μm and 1.08 μm.

7. The system of claim 1, wherein the first ytterbium doped fiber has a first gain medium excitation wavelength, and the second ytterbium doped fiber has a second gain medium excitation wavelength.

8. The system of claim 7, wherein the first gain medium excitation wavelength is lower than the second gain medium excitation wavelength.

9. The system of claim 8, wherein the first gain medium excitation wavelength is at a minimum with respect to the second gain medium excitation wavelength and the second gain medium excitation wavelength is at a maximum with respect to the first gain medium excitation wavelength.

10. The system of claim 1, wherein the first ytterbium doped fiber has a core radius of about 3.4 μm and the second ytterbium doped fiber has a core radius of about 3.4 μm.

11. The system of claim 1, wherein the first ytterbium doped fiber has a doping radius of about 2.4 μm and second ytterbium doped fiber has a doping radius of about 2.4 μm.

12. The system of claim 7, wherein the system is operated between 275 degrees Kelvin and 325 degrees Kelvin.

13. The system of claim 12, wherein the system has a signal attenuation of about 0.1 dB.

14. The system of claim 13, wherein the first pump has a signal attenuation of about 0.15 dB and the second pump has a signal attenuation of about 0.15 dB.

15. The system of claim 1, wherein the first ytterbium doped fiber has a cladding radius of about 62.5 μm and the second ytterbium doped fiber has a cladding radius of about 62.5 μm.

16. The system of claim 1, wherein the first pump is operated at a power between 2 Watts and 6 Watts, and the second pump is operated at a power between 2 Watts and 6 Watts.

17. A system for amplifying optical signals, the system comprising:
a first isolator configured to receive an input signal and convert the input signal into a first isolated signal;
a first pump configured to generate first pump photons;
a first coupler configured to receive and join the first isolated signal and the first pump photons into a first pumped signal;
a first gain medium configured to receive the first pumped signal and convert the first pumped signal to a first amplified signal;
a second isolator configured to receive the first amplified signal and convert the first amplified signal into a second isolated signal;
a second pump configured to generate second pump photons;
a second coupler configured to receive and join the second isolated signal and the second pump photons into a second pumped signal;
a second gain medium configured to receive the second pumped signal and convert the second pumped signal into a second amplified signal;
a third isolator configured to receive the second amplified signal and convert the second amplified signal into an amplified optical signal;
wherein the first gain medium is excited using a wavelength with a lower photon absorption rate than the second gain medium; and
the first pump is operated at a minimum power with respect to the power at which the second pump is operated.

18. The system of claim 17, wherein the first gain medium is a first ytterbium doped fiber, the first ytterbium doped fiber having a length of about 1 meter and a Yb³⁺ concentration of about 50×10²⁴ m⁻³.

19. The system of claim 18, wherein the second gain medium is a second ytterbium doped fiber, the second ytterbium doped fiber having a length of about 6 meters and a Yb³⁺ concentration of about 50×10²⁴ m⁻³.

20. The system of claim 18, wherein the input signal is between 1.02 μm and 1.08 μm.
